(19) United States
(12) Patent Application Publication
(10) Pub. No.: US 2012/0056415 A1
(43) Pub. Date: Mar. 8, 2012

(54) Flange Seal

(76) Inventor: Craig Oldnall, Atwell (AU)

(21) Appl. No.: 13/274,428

(22) Filed: Oct. 17, 2011

Related U.S. Application Data
(63) Continuation of application No. PCT/AU2010/000412, filed on Apr. 15, 2010.

(30) Foreign Application Priority Data
Apr. 17, 2009 (AU) 2009901636

(51) Int. Cl. F16L 23/036; F16L 55/00

(52) U.S. Cl. 285/92; 285/363; 285/93; 285/81

(57) ABSTRACT

A flange seal (10) for forming a sealed connection between a first flange (12) and a second flange (14) connected by a plurality of flange bolts (22). The flange seal (10) comprises a first portion (26) and a second portion (28). The first and second portions (26, 28) are locatable between the first and second flanges (12,14) such that a chamber (44) is defined between the first and second portions (26,28). The supply of hydraulic fluid to the chamber (44) via a hydraulic input (48) causes the first and second portions (26,28) to move away from each other such that the first and second flanges (12,14) engage against ends of the flange bolts (22) and outer surfaces (32,33) of the first and second portions (26,28) engage against end surfaces (32,33) of the respective flanges (12,14) to create a seal between the flanges (12,14).

### RELATED APPLICATIONS

This Application is a Continuation application of International Application PCT/AU2010/000412, filed on Apr. 15, 2010, which in turn claims priority to Australian Patent Applications No. AU 2009901636, filed Apr. 17, 2009, all of which are incorporated herein by reference in their entirety.

### FIELD OF THE INVENTION

The present invention relates to apparatus for providing a sealed connection between members having flanged ends.

### BACKGROUND OF THE INVENTION

Sections of piping having end flanges that are joined together to form longer lengths of pipe are commonly used in many industrial applications. The usual method of connecting together such lengths of pipe is via bolts which are passed through a series of holes spaced evenly around the flanges and then tightened.

In order to provide the required seal between the two flanges, the bolts in such an arrangement must be tightened to a predetermined tension. As the tension required for large flanges can be significant, tools designed for supplying the required tension are often required. In one such method, the bolts are gripped by a tool which applies a hydraulic force to pull and thereby stretch the bolt. Once sufficient tension is supplied, the nut can be wound down against the flanges and the tension released. This method allows for more accurate tensioning than simply rotating the nuts with a tool for supplying torque as it is not necessary to also overcome the friction generated between the nut and the flange.

In such methods as this, it is generally necessary to tighten only a selected number of nuts at any one time and then subsequently tighten the other nuts in a particular pattern to ensure the flanges are pulled together evenly. On large flanges in industrial applications having a large number of flange bolts, the process of closing or opening the connection can therefore take many hours of labour. Also, if the closing process is not performed correctly, the flanged join may leak.

Hydraulically actuated flange closing methods have been proposed to reduce the time required to seal the connection between the flanges, in comparison to manually tightening flange bolts. Many of the methods proposed however require a particular type of flange to be used, or modification of the joint. Such systems would result in additional costs to be incurred in order to retrofit such a hydraulic system to existing flange connections.

The present invention relates to apparatus for connecting flanges aimed at simplifying the connection and disconnection processes.

### SUMMARY OF THE INVENTION

According to one aspect of the present invention there is provided a flange seal for forming a sealed connection between a first flange and a second flange connected by a plurality of flange bolts around the periphery thereof, the flange seal comprising:
a first portion locatable between the first and second flanges such that an outer surface thereof engages with an end surface of the first flange;
a second portion locatable between the first and second flanges such that an outer surface thereof engages with an end surface of the second flange; and
a chamber defined between the first and second portions connected to a hydraulic input;
wherein the supply of hydraulic fluid to the chamber via the hydraulic input causes the first and second portions to move away from each other such that the first and second flanges engage against ends of the flange bolts and the outer surfaces of the first and second portions engage against the end surfaces of the respective flanges to create a seal between the flanges.

Preferably the first portion includes an inner surface adjacent the second portion and the inner surface of the first portion includes an annular recess into which the second portion is received such that said chamber is defined between the second portion and an inner surface of the annular recess.

The flange seal preferably comprises a generally cylindrical body formed by a cylindrical first portion and a cylindrical second portion.

In one embodiment, the first and second flanges are provided on respective first and second conduits and each of the first and second portions includes respective first and second central apertures to align in use with apertures in the first and second flanges.

In a preferred embodiment, a first seal member is provided around the periphery of the second portion that engages with an inner wall of the recess to provide a seal between the first and second portions at this point.

The second portion is preferably provided with a first cylindrical collar extending from around the circumference of the second central aperture, the first cylindrical collar being received in use within the first central aperture of the first portion. The first portion of the flange seal is preferably provided with a second cylindrical collar comprising an annular wall portion defined between the recess and the first central aperture, the second cylindrical collar being received in use around the first cylindrical collar. In a preferred embodiment, a circular groove is provided around the first cylindrical collar into which the second cylindrical collar is received.

In one embodiment, the first cylindrical collar is tapered such that it is thinner at the edge thereof to allow fluid flowing within the flange seal to deform the first cylindrical collar outwardly adjacent the edge towards the first portion.

Preferably a second seal member is provided in the second inner surface adjacent the circular groove such that the second seal member engages adjacent the outer surface of the second cylindrical collar.

Preferably the second portion is provided with a locking ring having an inner thread that engages with an outer thread provided around an outer wall of the second portion such that the locking ring can be rotated to engage with the first portion thereby preventing the first portion moving towards the second portion when hydraulic pressure in the chamber is reduced.

In an alternative embodiment, a non-return valve is provided such that hydraulic pressure within the chamber is maintained on disconnection of the hydraulic fluid source. A pressure indicator may be provided to provide an indication of the hydraulic pressure in the chamber. In one embodiment, the pressure indicator comprises a pressure gauge located externally of the flange seal.

According to a second aspect of the present invention, there is provide a flange seal for forming a sealed connection between a first flange and a second flange connected by a plurality of flange bolts around the periphery thereof, the flange seal comprising:
a first portion integrally formed with the first flange;
a second portion to be located between the first portion and the second flange such that an outer surface thereof engages with an end surface of the second flange, the second portion including a second central aperture;
an annular recess in an inner surface of the first portion into which the second portion is received such that a chamber is defined between the second portion and an inner surface of the annular recess;
a first cylindrical collar located on an inner side of the annular recess;
a second cylindrical collar being received in use around the first cylindrical collar; and
a hydraulic input connected to the chamber;
wherein the supply of hydraulic fluid to the chamber via the hydraulic input causes the first and second portions to move away from each other such that the first and second flanges engage against ends of the flange bolts and the outer surface of the second portion engages against the end surface of the second flange to create a seal.

A circular groove is preferably provided around the first cylindrical collar into which the second cylindrical collar is received. The first cylindrical collar may be tapered such that it is thinner at the edge thereof to allow fluid within the second central aperture of the second portion to deform the first cylindrical collar outwardly adjacent the edge, moving it towards the first portion.

Preferably nuts are provided on ends of the flange bolts to engage with the first and second flanges.

### BRIEF DESCRIPTION OF THE DRAWINGS

The invention will now be described, by way of example, with reference to the following drawings in which:

FIG. 1 is a side cross sectional view of a flange seal in accordance with the present invention;

FIG. 2 is a side view of the flange seal of FIG. 1 with portions cut away;

FIG. 3 is a side cross sectional view of the flange seal applied to a blind end;

FIG. 4 is a side cross sectional view of a flange seal in accordance with the present invention applied a ring type joint

FIG. 5 is a side cross sectional view of a flange seal according to the second aspect of the invention applied to a welded neck joint;

FIG. 6 is a side cross sectional view of a flange seal according to the second aspect of the invention applied to a blind end;

FIG. 7 is a side cross sectional view of a flange seal according to the second aspect of the invention applied to a welded neck on a ring type joint; and

FIG. 8 is a side cross sectional view of a flange seal according to the second aspect of the invention applied to a blind end on a ring type joint.

### DETAILED DESCRIPTION OF THE PREFERRED EMBODIMENTS

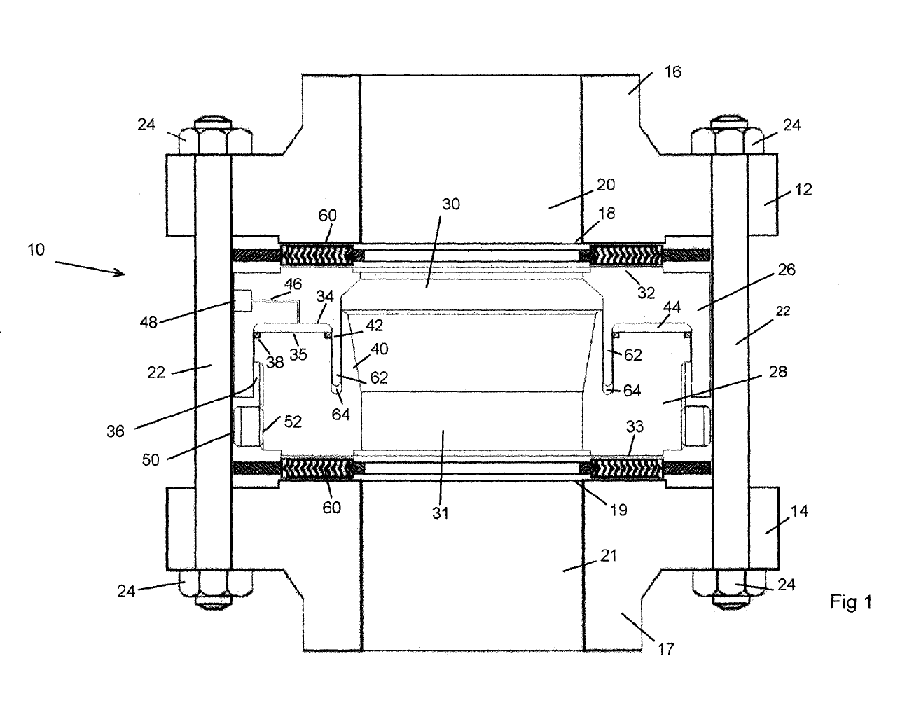

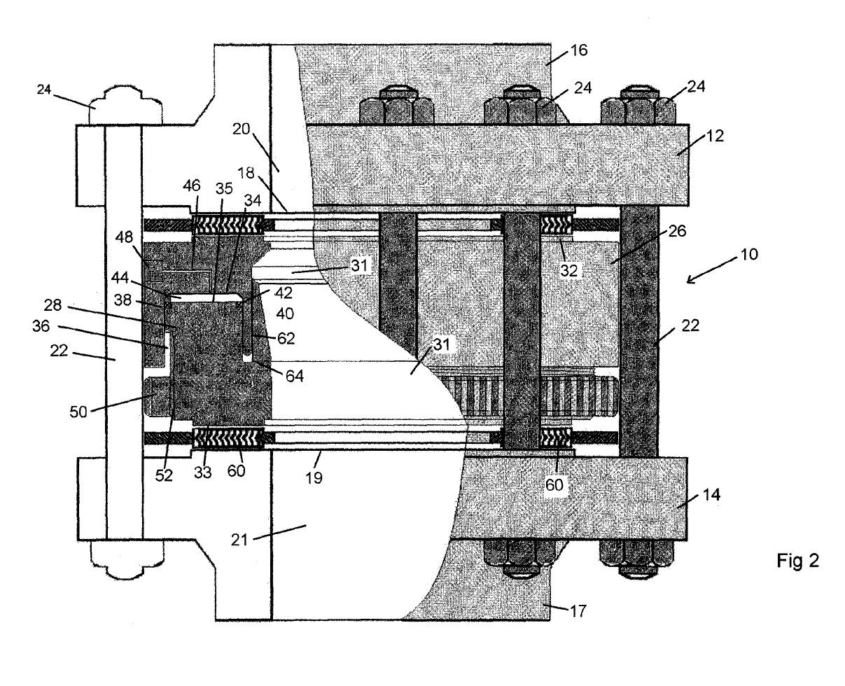

Referring to FIGS. 1 and 2, there is shown a flange seal 10 for sealing between a first flange 12 and a second flange 14. In the embodiment shown, the first flange 12 comprises a standard circular flange on a first conduit 16. The first flange 12 includes an end surface 18 having a central circular aperture 20 extending into the first conduit 16. The second flange 14 comprises also a standard circular flange on a second conduit 17. The second flange 14 includes an end surface 19 having a central circular aperture 21 extending into the second conduit 17.

The first and second flanges 12 and 14 include one or more connecting members provided to connect the first and second flanges together and limit the distance that the first and second flanges 12 and 14 may move apart. In the embodiment shown, the connecting members comprise a plurality of flange bolts 22 extending through corresponding holes around the periphery of the first and second flanges 12 and 14.

Each of the flange bolts 22 is provided with nuts 24 adjacent ends thereof. The nuts 24 are located on the flange bolts 22 such that the first and second flanges 12 and 14 can move away from each other until the flanges engage with the nuts 24. The length of the flange bolts 22 is such that the flange seal 10 can be located between the end surfaces 18 and 19 of the first and second flanges 12 and 14 (as shown in FIG. 1).

The flange seal 10 comprises a generally cylindrical body formed by a first portion 26 and a second portion 28. The flange seal 10 comprises a discrete component formed from discrete first and second portions 26 and 28 such that it can be placed between the first and second flanges and subsequently removed if required. Each of the first and second portions 26 and 28 are generally cylindrical and include respective first and second central apertures 30 and 31 therein arranged to align in use with the apertures 20 and 21 in the flanges 12 and 14 when the flange seal 10 is placed between the flanges 12 and 14.

The first portion 26 includes an outer surface 32 which engages in use with the end surface 18 of the first flange 12. The second portion 28 includes also an outer surface 33 which engages in use with the end surface 19 of the second flange 14. The first portion 26 also includes an inner surface 34 adjacent an inner surface 35 the second portion 28. The inner surface 34 of the first portion 26 includes an annular recess 36 such that the second portion 28 of the flange seal 10 is received in the annular recess 36. The second portion 28 is sized such that it is received within the annular recess 36 in the first portion 26 with minimal clearance. A first seal member 38 is provided around the periphery of the second portion 28 that engages with the inner wall of the recess 36 to provide a seal between the first and second portions 26 and 28 at this point.

The second portion 28 is provided also with a first cylindrical collar 40 extending from around the circumference of the central aperture 30. The cylindrical collar 40 is received in use within the first central aperture 30 of the first portion 26.

The first portion 26 of the flange seal 10 is provided with a second cylindrical collar 62. The second cylindrical collar 62 comprises an annular wall portion of the first portion 26 defined between the recess 36 and the first central aperture 30. The second cylindrical collar 62 is received around the first cylindrical collar 40 with minimal clearance between the first and second collars 40 and 62. Also, a circular groove 64 is provided around the first cylindrical collar 40 on the second portion 28 into which the second cylindrical collar 62 is received.

A second seal member 42 is provided in the second inner surface 35 adjacent the circular groove 64 such that the second seal member 42 engages adjacent the outer surface of the second cylindrical collar 62. The arrangement of the second cylindrical collar 62 being received in the circular groove 64 around the first cylindrical collar 40 allows the second seal member 42 to be located further from fluid flowing within the conduits 16 and 17. As it is expected that the flange seal 10 may be used on conduits carrying fluid at high temperate, this arrangement is expect to reduce the temperature present at the seal member 42 and thereby increase the life of the seal member 42.

The first cylindrical collar 40 is also tapered such that it is thinner at the edge thereof. Such an arrangement is provided to allow fluid within the conduits 16 and 17 to deform the collar 40 outwardly adjacent the edge, moving it against the first portion 26 thereby creating a better seal.

The first and second inner surfaces 34 and 35 define an annular chamber 44 bound by the first and second seal members 38 and 42. The first portion 26 of the flange seal 10 includes a channel 46 connecting between the chamber 44 and a hydraulic input 48. With this arrangement, connection of a hydraulic fluid source to the hydraulic input 48 supplies hydraulic fluid to the chamber 44 via the channel 46 in the first portion 26. The first and second portions 26 and 28 may therefore be moved away from each other hydraulically by the action of hydraulic fluid expanding the chamber 44.

The second portion 28 of the flange seal 10 is also provided with a locking ring 50. The locking ring 50 includes an inner thread that engages with an outer thread provided around an outer wall 52 of the second portion 28.

In use, the flange seal 10 is located between the first and second flanges 12 and 14 such that the outer surfaces thereof 32 and 33 are aligned to engage with the end surfaces 18 and 19 of the flanges 12 and 14. Suitable gaskets 60 may be provided between the end surfaces 18 and 19 and the first and second portions 26 and 28 to aid in sealing between the flange seal 10 and the flanges 12 and 14. Further, the outer surfaces 32 and 33 and the end surfaces 18 and 19 may be provided with a gramophone finish to increase the surface area and aid in compressing the gasket 60 to create a better seal.

The flange bolts 22 are arranged in place such that the nuts 24 are located at the same distance apart on each flange bolt 22. A hydraulic fluid supply (not shown) is connected to hydraulic input 48 on the flange seal 10 and the supply of hydraulic pressure into the chamber 44 causes the first and second portions 26 and 28 to move away from each other, engaging with the end surfaces 18 and 19 of the flanges 12 and 14 and forcing the flanges 12 and 14 against the nuts 24 on the flange bolts 22. Sufficient hydraulic pressure is provided to simultaneously tension all of the bolts 22 to the correct level.

Once tensioned, the locking ring 50 can be rotated on the outer thread on the second portion 28 to move the locking ring 50 towards the first portion 26 of the flange seal 10. The locking ring 50 is moved until it engages with the first portion 26, thereby locking the first and second portions 26 and 28 apart so that the hydraulic force can be removed while retaining the force on the flanges 12 and 14.

It will be appreciated that the flange seal thereby allows hydraulic tensioning of the entire flanges 12 and 14 without the need to individually tension each flange bolt 22. As the flange seal 10 described comprises a separate unit to be fitted between standard flanges utilising the existing flange bolts 24 to provide the resistance against which the seal is created, the flange seal 10 allows application without any modification of the existing flanges. It therefore has wide application as a device that can be retrofit to existing flanged connections.

Also, because of its configuration, the flange seal 10 can be used to close a gap in pipework that cannot be closed by pulling the pipework into alignment. Further, the flange seal arrangement it expected to be particularly useful on connections that must routinely be broken down for maintenance. When the flange seal 10 is removed, it will leave a gap that will aid in the removal of pipe spools or valves in cases where a pipe spreader would normally be required to create such a gap.

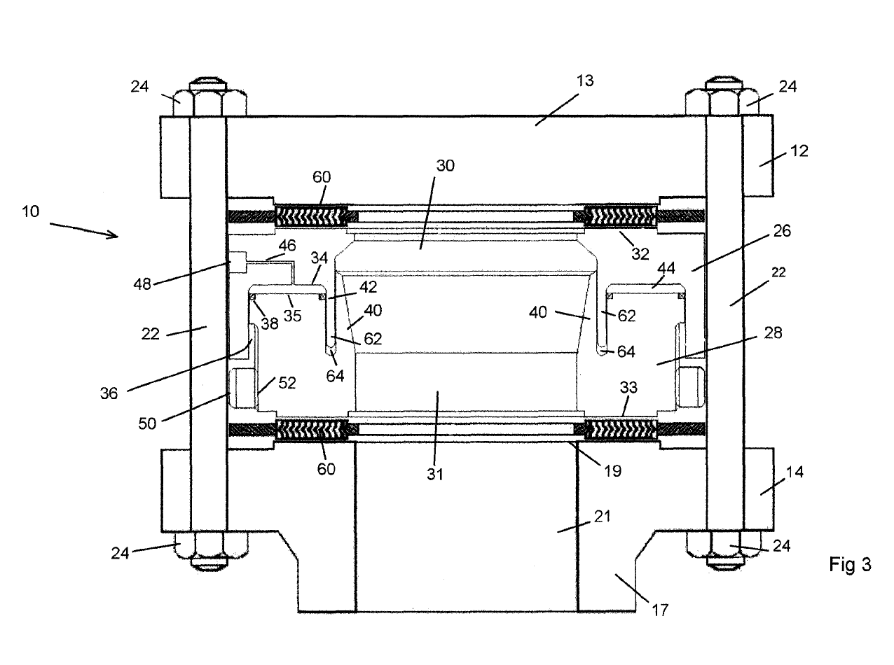

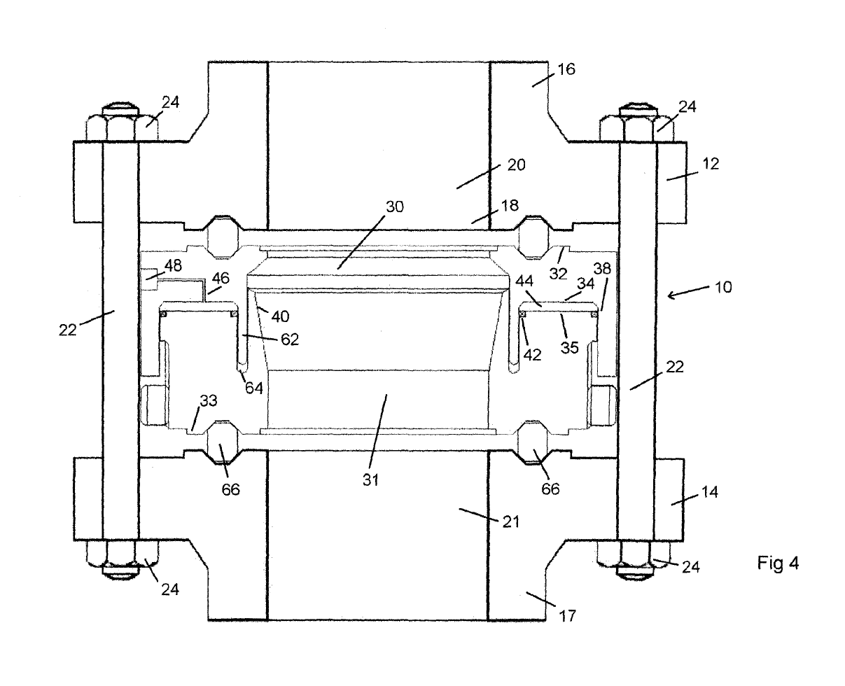

FIGS. 3 and 4 show alternate applications of a flange seal 10 in the cases of a blind end (FIG. 3) and a ring type joint (FIG. 4). In the case of a blind end the second flange 12 is provided on a solid cover plate 13. For the ring type joint, the end surfaces 18 and 19 of the flanges and the outer surfaces 32 and 33 are provided with angled circular grooves therein to receive a metal ring type gasket 66. The operation of the flange seal 10 in FIGS. 3 and 4 is however the same as that described with reference to FIGS. 1 and 2.

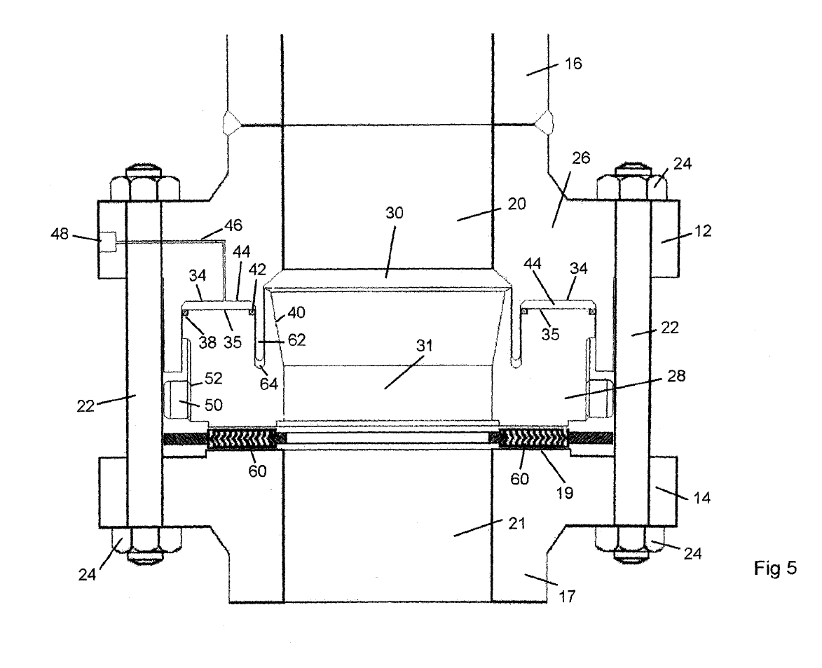

FIGS. 5 to 8 show alternate embodiments of a flange seal 10 in accordance with the second aspect of the present invention.

In the embodiment of FIG. 5, the first portion 26 is formed integrally with the first flange 12 but retains essentially the same features of the first portion 26 as described with reference to FIGS. 1 to 4. The gasket 60 between the first portion 26 and the first flange 12 is however no longer required. Like reference numerals are used to denote like parts.

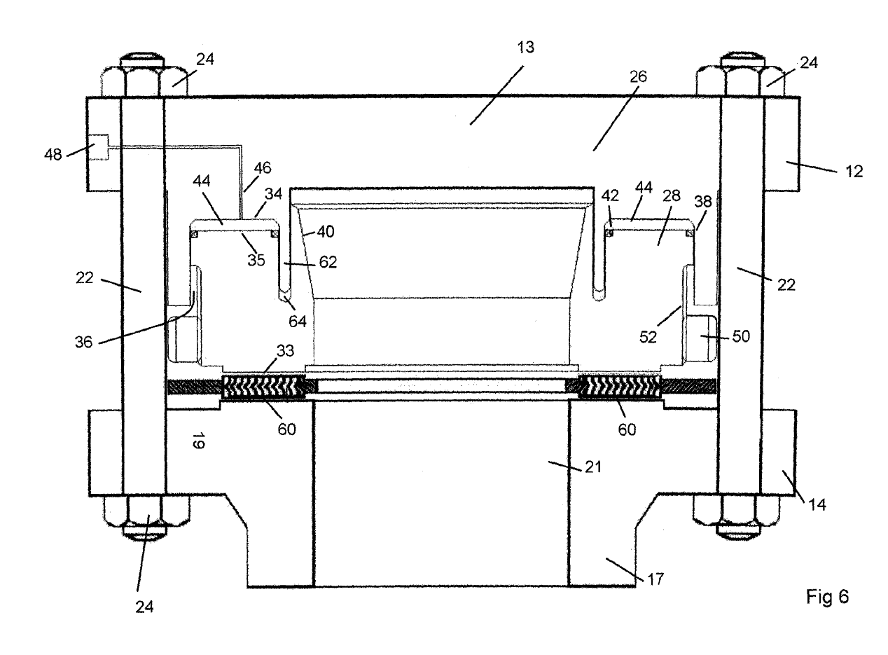

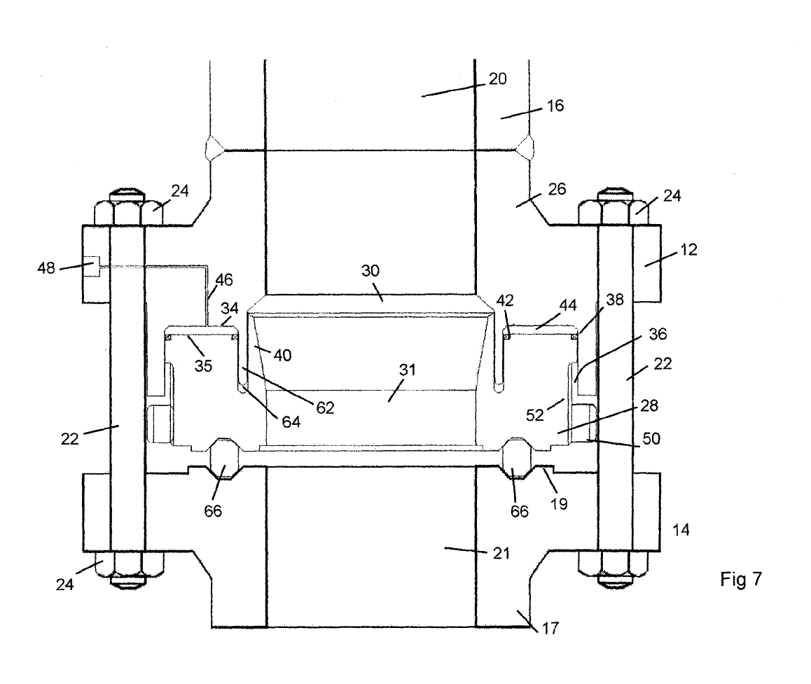

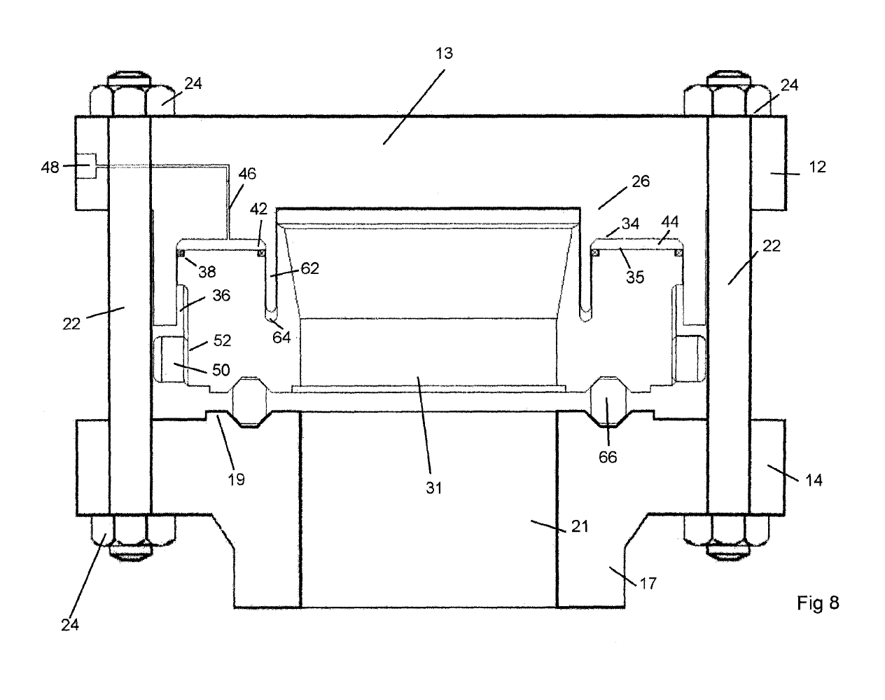

FIG. 6 shows an embodiment utilising the same method as FIG. 5 wherein the first portion 26 is integrally formed with the cover plate 13. FIG. 7 shows an embodiment the same as FIG. 5 but with a ring type joint and FIG. 8 shows an embodiment the same as FIG. 6 but with a ring type joint.

In an alternative embodiment of the present invention, there is provided a non-return valve (not shown) in the hydraulic input 48. The non-return valve results in hydraulic pressure in the chamber 44 being maintained when the hydraulic fluid source is disconnected. It is expected that in such an embodiment, the locking ring 50 is not used to lock the first and second portions 26 and 28 relative to each other on release of the pressure but is simply rotated adjacent the first portion 26 to prevent movement should the hydraulic pressure drop or be released, for example should there be a failure in the non-return valve or seals.

In such an embodiment, a pressure indicator is provided to provide an indication of the hydraulic pressure in the chamber 44. The pressure indicator may comprise a gauge located externally of the flange seal 10. Alternatively, the pressure indicator may comprise a pressure sensor coupled to a remote monitoring system. The pressure indicator provides an indication that pressure has dropped in the chamber 44 thereby allowing appropriate action to be taken to rectify the situation.

It will be readily apparent to persons skilled in the relevant arts that various modifications and improvements may be made to the foregoing embodiments, in addition to those already described, without departing from the basic inventive concepts of the present invention.

What is claimed is:

1. A flange seal for forming a sealed connection between a first flange and a second flange connected by a plurality of flange bolts around the periphery thereof, the flange seal comprising:
a first portion locatable between the first and second flanges such that an outer surface thereof engages with an end surface of the first flange;
a second portion locatable between the first and second flanges such that an outer surface thereof engages with an end surface of the second flange; and
a chamber defined between the first and second portions connected to a hydraulic input;
wherein the supply of hydraulic fluid to the chamber via the hydraulic input causes the first and second portions to move away from each other such that the first and second flanges engage against ends of the flange bolts and the outer surfaces of the first and second portions engage against the end surfaces of the respective flanges to create a seal between the flanges.

2. The flange seal in accordance with claim 1, wherein the first portion includes an inner surface adjacent the second portion and the inner surface of the first portion includes an annular recess into which the second portion is received such that said chamber is defined between the second portion and an inner surface of the annular recess.

3. The flange seal in accordance with claim 2, wherein the flange seal comprises a generally cylindrical body formed by a cylindrical first portion and a cylindrical second portion.

4. The flange seal in accordance with claim 3, wherein the first and second flanges are provided on respective first and second conduits and each of the first and second portions includes respective first and second central apertures to align in use with apertures in the first and second flanges.

5. The flange seal in accordance with claim 2, wherein a first seal member is provided around the periphery of the second portion that engages with an inner wall of the recess to provide a seal between the first and second portions at this point.

6. The flange seal in accordance with claim 5, wherein the second portion is provided with a first cylindrical collar extending from around the circumference of the second central aperture, the first cylindrical collar being received in use within the first central aperture of the first portion.

7. The flange seal in accordance with claim 6, wherein the first portion of the flange seal is provided with a second cylindrical collar comprising an annular wall portion defined between the recess and the first central aperture, the second cylindrical collar being received in use around the first cylindrical collar.

8. The flange seal in accordance with claim 7, wherein a circular groove is provided around the first cylindrical collar into which the second cylindrical collar is received.

9. The flange seal in accordance with claim 7, wherein the first cylindrical collar is tapered such that it is thinner at the edge thereof to allow fluid flowing within the flange seal to deform the first cylindrical collar outwardly adjacent the edge towards the first portion.

10. The flange seal in accordance with claim 8, wherein a second seal member is provided in the second inner surface adjacent the circular groove such that the second seal member engages adjacent the outer surface of the second cylindrical collar.

11. The flange seal in accordance with claim 1, wherein the second portion is provided with a locking ring having an inner thread that engages with an outer thread provided around an outer wall of the second portion such that the locking ring can be rotated to engage with the first portion thereby preventing the first portion moving towards the second portion when hydraulic pressure in the chamber is reduced.

12. The flange seal in accordance with claim 1, wherein a non-return valve is provided such that hydraulic pressure within the chamber is maintained on disconnection of the hydraulic fluid source.

13. The flange seal in accordance with claim 12, wherein a pressure indicator is provided to provide an indication of the hydraulic pressure in the chamber.

14. The flange seal in accordance with claim 13, wherein the pressure indicator comprises a pressure gauge located externally of the flange seal.

15. A flange seal for forming a sealed connection between a first flange and a second flange connected by a plurality of flange bolts around the periphery thereof, the flange seal comprising:
a first portion integrally formed with the first flange;
a second portion to be located between the first portion and the second flange such that an outer surface thereof engages with an end surface of the second flange, the second portion including a second central aperture;
an annular recess in an inner surface of the first portion into which the second portion is received such that a chamber is defined between the second portion and an inner surface of the annular recess;
a first cylindrical collar located on an inner side of the annular recess;
a second cylindrical collar being received in use around the first cylindrical collar; and
a hydraulic input connected to the chamber;
wherein the supply of hydraulic fluid to the chamber via the hydraulic input causes the first and second portions to move away from each other such that the first and second flanges engage against ends of the flange bolts and the outer surface of the second portion engages against the end surface of the second flange to create a seal.

16. The flange seal in accordance with claim 15, wherein a circular groove is provided around the first cylindrical collar into which the second cylindrical collar is received.

17. The flange seal in accordance with claim 16, wherein the first cylindrical collar is tapered such that it is thinner at the edge thereof to allow fluid within the second central aperture of the second portion to deform the first cylindrical collar outwardly adjacent the edge, moving it towards the first portion.

18. The flange seal in accordance with claim 17, wherein a first seal member is provided around the periphery of the second portion that engages with an inner wall of the recess to provide a seal between the first and second portions at this point.

19. The flange seal in accordance with claim 18, wherein a second seal member is provided in the second portion adjacent the circular groove such that the second seal member engages adjacent the outer surface of the second cylindrical collar.

20. The flange seal in accordance with claim 15, wherein the second portion is provided with a locking ring having an inner thread that engages with an outer thread provided around an outer wall of the second portion such that the locking ring can be rotated to move the locking ring to engage with the first portion thereby preventing the first portion moving towards the second portion when hydraulic pressure in the chamber is reduced.

20. The flange seal in accordance with claim 15, wherein a non-return valve is provided such that hydraulic pressure within the chamber is maintained on disconnection of the hydraulic fluid source.

21. The flange seal in accordance with claim 20, wherein a pressure indicator is provided to provide an indication of the hydraulic pressure in the chamber.

22. The flange seal in accordance with claim 21, wherein the pressure indicator comprises a pressure gauge located externally of the flange seal.

23. The flange seal in accordance with claim 15, wherein nuts are provided on ends of the flange bolts to engage with the first and second flanges.
